(19) United States
(12) Patent Application Publication
(10) Pub. No.: US 2025/0060381 A1
(43) Pub. Date: Feb. 20, 2025

(54) POSITION TRACKING SYSTEM AND METHOD FOR TRACKING A RELATIVE POSITION OF CONNECTED MODULES

(71) Applicant: Roche Diagnostics Operations, Inc., Indianapolis, IN (US)

(72) Inventors: Vladimirs Leontjevs, Ludwigsburg (DE); Philipp Riedel, Rotkreuz (CH)

(73) Assignee: Roche Diagnostics Operations, Inc., Indianapolis, IN (US)

(21) Appl. No.: 18/937,855

(22) Filed: Nov. 5, 2024

Related U.S. Application Data
(63) Continuation of application No. PCT/EP2023/061962, filed on May 5, 2023.

(30) Foreign Application Priority Data
May 5, 2023 (EP) 22171981.8

(51) Int. Cl. G01N 35/00

(52) U.S. Cl. CPC G01N 35/00623; G01N 2035/00326; G01N 2035/00643

(57) ABSTRACT

A position tracking system for tracking a relative position between connected modules. A target is arrangeable on and/or within a first connected module, the connected modules mechanically interacting for transporting objects between modules; a position sensor is arrangeable on and/or within a second connected module and is configured for generating a sensor signal according to a relative position between the position sensor and target, a processing unit configured for tracking a relative position between the connected modules from the sensor signal; and a second sensor is configured for generating a second sensor signal according to at least a second parameter, wherein the second sensor is a temperature sensor and/or a humidity sensor, the processing unit being configured for considering the second sensor signal when determining the relative position between the connected modules. Further disclosed are related monitoring systems and methods for tracking and monitoring at least two connected modules.

### TECHNICAL FIELD

The present invention relates to a position tracking system for tracking a relative position between at least two connected modules and a monitoring system for monitoring at least two connected modules. Further, the present invention relates to a method for tracking a relative position between at least two connected modules by using the position tracking system and to a method for monitoring at least two connected modules by using the monitoring system. The systems and methods of the present invention, as an example, may be used for controlling and/or detecting changes in a relative position between different units of a laboratory line, such as in a modular laboratory, specifically in the field of modular diagnostic laboratories. The systems and methods can also be used for other applications requiring controlling and/or detecting changes in relative position, for example of a production line, such as of a manufacturing or assembly line, i.e. in a manufacturing site.

### BACKGROUND ART

In the field of modular diagnostic laboratories, generally, a plurality of modules and/or units have to be positioned in order to form laboratory lines, wherein the positions typically have to be maintained within narrow tolerances in order not to jeopardize the safety and functionality of handling and transport processes between these modules and/or units. Specifically, narrow positioning tolerance generally have to be preserved when handling and transporting laboratory equipment, such as sample containers, for example sample tubes filled with biological fluids to be analyzed, and/or cassettes filled with reagents, specimen slides, tissue material, waste or the like, in modular diagnostic laboratories.

For maintaining relative positions between modules and/or units, specifically under varying environmental conditions and influences, such as changes in temperature and/or humidity, and mechanical influences, such as vibrations, several concepts exist. In general, materials, shapes and positions of connecting elements, specifically of reversibly connecting elements, such as screws and/or clamps, are carefully selected according to their response to these environmental conditions and influences. However, changes in the relative positions between modules and/or units, for example due to material fatigue and/or deformation, often stay unknown and/or undetected, until errors occur, often in a larger scale, i.e. in subsequent experiments and/quality checks.

Various concept for predicting changes in relative positions between modules and/or units exist, for example using artificial intelligence, teaching, automated teaching or tolerance chain optimization.

Thereby, the term teaching refers to aligning of the relative positions between modules and/or units. In that sense, EP 3 153 866 A1 discloses a method for determining a handover position of a gripping device and a laboratory automation system being able to perform such a method. A position determining device is used in order to determine a handover position based on magnetic forces of a handover electro-magnetic actuator that is part of a laboratory sample distribution system of the laboratory automation system. Further in that sense, EP 3 260 868 A1 discloses a method of setting a handover position of a gripping device at a laboratory automation system, wherein a position of a position determining device held by the gripping device is detected using position sensors in order to determine the handover position. EP 3 260 868 A1 discloses further a laboratory automation system being configured to perform such a method.

The aligning of the relative positions between modules and/or units may be, particularly, of great importance in a scenario in which a plurality of adjoining modules and/or units, have to be aligned, so that the deviations of these adjoining module and/or unit may accumulate. These adjoining modules and/or units may, therefore, build so-called tolerance chains that have to be optimized.

However, despite the advantages achieved by these concepts, several technical challenges remain. Specifically, unrecognized changes in the relative positioning of modules and/or units due to environmental conditions and influences may still occur. For example, influences of overlooked or unconsidered environmental conditions may have an effect on the positioning. Further, unintentionally induced position changes, i.e. by laboratory or cleaning personnel, may go unnoticed until an error occurs, possibly leading to damage that otherwise, i.e. by early detection, could have been avoided.

### PROBLEM TO BE SOLVED

It is therefore desirable to provide systems and methods, which at least partially address the above-mentioned technical challenges. Specifically, a position tracking system, a monitoring system, a method for tracking relative position between at least two connected modules and a method for monitoring at least two connected modules shall be proposed which allow for preventing problems arising from unrecognized changes in the relative positioning of modules.

### SUMMARY

This problem is addressed by a position tracking system for tracking a relative position between at least two connected, specifically mechanically interacting, modules, a monitoring system for monitoring at least two connected modules, a method for tracking a relative position between at least two connected modules and a method for monitoring at least two connected modules with the features of the independent claims. Advantageous embodiments, which might be realized in an isolated fashion or in any arbitrary combinations, are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

The present invention, a position tracking system for tracking a relative position between at least two connected modules is disclosed. The position tracking system comprises:
at least one target associated with a first one of the at least two connected modules;
at least one position sensor associated with a second one of the at least two connected modules, wherein the position sensor is configured for generating at least one sensor signal according to a relative position between the at least one position sensor and the at least one target; and
at least one processing unit, such as a processor, configured for tracking a relative movement between the connected modules from the at least one sensor signal in at least one plane.

The term “connected module” as used herein is a broad term and is to be given its ordinary and customary meaning to a person of ordinary skill in the art and is not to be limited to a special or customized meaning. The term specifically may refer, without limitation, to an entity and/or component physically bound and/or engaged with another entity and/or component. In particular, the at least two connected modules may be physically connected modules, such as modules, e.g. via at least one connection element. Specifically, the at least two connected modules may be or may comprise at least two mechanically interacting entities and/or components. In particular, the two connected modules, specifically via connection, may allow for transport of objects, such as laboratory equipment, from one module to the other module. For example, two connected modules may be configured for transporting objects via at least one interface between the two connected modules, such as via at least one gap and/or slit, between the two modules. In particular, the at least two connected modules may be part of at least one laboratory line, specifically in at least one modular diagnostic laboratory. Specifically, the at least two connected modules may both be modules of a modular diagnostic laboratory. As an example, the at least two connected modules may be configured for instantly interacting when being connected, such as interacting without requiring professional installation, i.e. instant interaction as commonly called “plug and play”. Thus, as an example, the interface between the at least two connected modules may also be referred to as plug and play interface. In particular, though the position tracking system may be described referencing the at least two connected modules, the position tracking system may be a separate entity not comprising the two connected modules.

The position tracking system comprises at least one target and at least one position sensor. As an example, the target and the position sensor may form an impact pair or working couple, such that the position and/or movement of the target is trackable by the position sensor of the pair or couple.

The term “target” as used herein is a broad term and is to be given its ordinary and customary meaning to a person of ordinary skill in the art and is not to be limited to a special or customized meaning. The term specifically may refer, without limitation, to an arbitrary trackable element, such as an entity or marker configured for having its position tracked and/or detected, i.e. by a position sensor. As an example, the target may be an optically trackable element, such as a visible entity or maker, e.g. a visibly distinctive object, a color mark and/or a painted crossline. Additionally or alternatively, the target may be electronically trackable element, such as an entity having an electronic and magnetic field, for example an inductive or capacitive clement. In particular, the target may be an element selected from the group consisting of: an optically detectable element, i.e. a visible entity or a visible marker; a magnetoresistance detectable element; an inductive element; a capacitive element.

As an example, with respect to the position sensor, a movement of the target may be restricted to only two degrees of freedom. Specifically, a change of a position of the target with respect to the position of the position sensor may be restricted to two degrees of freedom.

In particular, a movement of the target may be trackable and/or detectable by using the at least one position sensor. The term “position sensor” as used herein is a broad term and is to be given its ordinary and customary meaning to a person of ordinary skill in the art and is not to be limited to a special or customized meaning. The term specifically may refer, without limitation, to an arbitrary device configured for detecting at least one position of the target. As an example, the position sensor may be or may comprise a camera for detecting the position of the target, i.e. of the optically detectable target, by image recognition. Additionally or alternatively, position sensor may be or may comprise at least one sensor configured for detecting a position of the target by using an electronic and/or magnetic field detection principle, such as by using an inductive and/or capacitive principle. Specifically, the position sensor may be capable of generating at least one sensor signal, such as a measurement signal, e.g. an electrical signal, which is a qualitative indicator of the position of the target, i.e. of the relative position between the position sensor and the target. As an example, the position sensor may specifically be selected from the group consisting of: an inductive sensor, a capacitive sensor, an optical sensor, and a magnetoresistance sensor; specifically selected from the group consisting of: an anisotropic magnetoresistance sensor, a giant magnetoresistance sensor, a colossal magnetoresistance sensor, and a tunnel magnetoresistance sensor.

In particular, the term “sensor signal” as used herein is a broad term and is to be given its ordinary and customary meaning to a person of ordinary skill in the art and is not to be limited to a special or customized meaning. The term specifically may refer, without limitation, to a measurement value over time, for example provided in form of an electrical signal over time. In particular, the sensor signal generated by the position sensor according to the relative position between the position sensor and the target may be or may comprise information on the relative position between the position sensor and the target over time, and thus may further comprise information on a relative movement between the position sensor and the target.

In particular, the position sensor may be configured for transmitting the sensor signal to the processing unit, for example by at least one wireless connection, e.g. via Bluetooth, near field communication or the like, or by wire-bound connection, such as via at least one cable. Other modes of transmitting the sensor signal from the position sensor to the processing unit may be possible.

The term “relative position” as used herein is a broad term and is to be given its ordinary and customary meaning to a person of ordinary skill in the art and is not to be limited to a special or customized meaning. The term specifically may refer, without limitation, to a spatial position of an arbitrary object or element in relation to a reference object or element. In particular, the term “relative position between the position sensor and the target” may refer to a spatial position of the target in relation to the position sensor, such as to a distance between the target and the position sensor. For example, the relative position between the position sensor and the target may be measured in a coordinate system, i.e. in a Cartesian coordinate system, specifically in a Cartesian coordinate system of the position sensor. The term “relative position between the connected modules” may refer to a spatial position of one of the two connected modules in relation to the other one of the connected modules. Specifically, the relative position between the connected modules may also be measured in a coordinate system, i.e. in a Cartesian coordinate system, specifically in a Cartesian coordinate system of the position sensor.

The relative position between the connected modules is tracked by the at least one processing unit of the position tracking system. The term “processing unit” or “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or computer system, and/or, generally, to a device which is configured for performing regulations or logic operations. As an example processing unit and/or processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processing unit and/or processor may be a multi-core processor. Specifically, the processing unit and/or processor may be or may comprise a central processing unit (CPU). As an example, the processing unit and/or processor may be configured for performing, such as by software programming, for performing at least one tracking operation, such as by calculating a relative position between the connected modules from the at least one sensor signal.

Specifically, the processing unit and/or processor may be configured for determining from the sensor signal the relative position between the connected modules over time in at least one plane, i.e. tracking a movement of the connected modules in at least one plane. The term “plane” as used herein is a broad term and is to be given its ordinary and customary meaning to a person of ordinary skill in the art and is not to be limited to a special or customized meaning. The term specifically may refer, without limitation, to a two-dimensional space. Thus, specifically, the processing unit may be configured for tracking the relative position between the connected modules in at least two spatial dimensions. As an example, a change in the relative position between the connected modules that is trackable by the processing unit by using only one sensor signal may be restricted to one plane, i.e. to two dimensions. In particular, the plane in which the movement of the connected modules may be trackable from the sensor signal may depend on the relative arrangement of the target and the position sensor, i.e. on the positions in which both the target and the position sensor are arranged. As an example, the plane may be or may comprise a symmetry plane between the position of the target and the position sensor, such as the symmetry plane in which the position of the target is symmetric to the position of the position sensor. Additionally or alternatively, the plane's normal vector may point in the direction of the shortest distance between the target and the position sensor, as originally arranged, i.e. in an installing position, specifically in an unchanged relative position, such as in a state where the relative position is unchanged.

The at least one target may specifically be at least one of arrangeable on and arrangeable within the first one of the at least two connected modules. In particular, the target may be arrangeable on the first one of the at least two connected modules, such as on a surface of the first connected module, specifically on a surface facing at least one surface of the second one of the at least two connected modules. Additionally or alternatively, the target may be arrangeable within the first one of the at least two connected modules, for example under a surface of the first connected module, specifically in an area close to a surface of the first connected module facing at least one surface of the second one of the at least two connected modules.

The at least one position sensor may be at least one of arrangeable on and arrangeable within the second one of the at least two connected modules. In particular, the position sent may be arrangeable on the second one of the at least two connected modules, such as on a surface of the second connected module, specifically on a surface facing at least one surface of the first one of the at least two connected modules. Additionally or alternatively, the position sensor may be arrangeable within the second one of the at least two connected modules, for example under a surface of the second connected module, specifically facing at least one surface of the first connected module on and/or within which the target may be arrangeable.

The at least one sensor signal may specifically be or may comprise a gradient field sensor signal. In particular, processing unit and/or processor of the position tracking system may be configured for transferring the sensor signal, i.e. the sensor signal generated by the at least one position sensor according to the relative position between the position sensor and the target, into the gradient field sensor signal, for example by calculating at least one gradient of the at least one sensor signal. The term “gradient field sensor signal” as used herein is a broad term and is to be given its ordinary and customary meaning to a person of ordinary skill in the art and is not to be limited to a special or customized meaning. The term specifically may refer, without limitation, to a vector field determined from a sensor signal function, such as from the sensor signal generated by the position sensor, by determining the gradient of the sensor signal function.

As an example, the sensor signal S generated by the position sensor may describe the position of the target in two spatial dimensions x and y over time t. Thus, as an example, the sensor signal describing the relative position of the target in relation to the position sensor S_{target} may be a function f, dependent on x and y, i.e. S_{target}=f(x,y,t). The gradient field sensor signal S_{target}__{grad} may be determined by the processing unit by using the following equation:

$${S}_{target \_ grad} = ∇ {S}_{target} = ( \begin{matrix}\frac{\partial {S}_{target}}{\partial x} \\ \frac{\partial {S}_{target}}{\partial y}\end{matrix} ) \qquad ( Eq . 1 )$$

The position tracking system may specifically comprise at least two targets and at least two position sensors. Specifically, the position tracking sensor may comprise at least two pairs and/or couples, each for example formed by one target and one position sensor.

In particular, a first position sensor and a first target may be arrangeable on different connected modules. As an example, the first position sensor may be configured for generating a first sensor signal, specifically according to a relative position between the first sensor and the first target. The first sensor signal, in particular, may comprise information on the relative position over time, i.e. on a movement, between the first target and the first position sensor, specifically in a first plane. Thus, the first pair and/or couple formed by the first target and the first position sensor, may specifically be configured for providing information relative movement between the first target and the first position sensor in the first plane, for example in a first and a second spatial dimension.

A second position sensor and a second target may also be arrangeable on different connected modules. In particular, the second position sensor may be configured to generate a second sensor signal, specifically according to a relative position between the second sensor and the second target. The second sensor signal may comprise information on the relative position over time, i.e. on a movement, between the second target and the second position sensor, specifically in a second plane. The second pair and/or couple formed by the second target and the second position sensor, may specifically be configured for providing information relative movement between the second target and the second position sensor in the second plane, for example in a first and a third spatial dimension.

The first plane may differ from the second plane. In particular, the first sensor signal may comprise information on a movement in the first plane, wherein the first plane may be different from the second plane. In particular, the second sensor signal may comprise information on a movement in the second plane, and thus, in a say different from the first plane. Specifically, a smallest angle a between the first plane and the second plane may differ from 0°, i.e. α≠0°. As an example, the first plane and the second plane may be arranged in an essentially orthogonal fashion. In particular, the first position sensor and the second position sensor, and additionally the first target and the second target, may be arranged and/or positioned such that the first plane and the second plane are arranged in an essentially orthogonal fashion. Thus, as an example, the first plane and the second plane may be arranged orthogonally, such as arranged perpendicular to each other. In particular, the angle a between the first plane and the second plane may be a right angle, specifically within a tolerance of ±5°, more specifically within a tolerance of ±3°. Thus, as an example, 85°≤α≤95°, preferably 87°≤α≤93°, more preferably 89°≤α≤91°, most preferred α=90°.

The processing unit, from the first sensor signal, may be able to track a relative position between the connected modules in the first plane. Thus, as an example, the processing unit may be configured for generating a position function P₁ describing the relative position between the connected modules in the first plane over time. As an example, the position function P₁ may be a function f, dependent on a first spatial dimension x, on a second spatial dimension y and on the time t. Thus, as an example P₁=f(x,y,t).

From the first sensor signal, the processing unit may be able to track a relative position between the connected modules in the second plane. Thus, as an example, the processing unit may be configured for generating a position function P₂ describing the relative position between the connected modules in the second plane over time. As an example, the position function P₂ may be a function f, dependent on a first spatial dimension x, on a third spatial dimension z and on the time t. Thus, as an example P₂=f(x,z,t).

In particular, the processing unit may be configured for determining a translational change in position, such as a translational movement, between the two connected modules from the first sensor signal and the second sensor signal. The translational change in position, i.e. the translational movement, may specifically be determined by comparing the relative position between the two modules over time, i.e. by comparing a present relative position with a previous relative position. Specifically, the processing unit may be configured for generating a position function P describing the relative position between the connected modules in both the first plane and the second plane over time. As an example, in case the first position sensor and the second position sensor, as well as the first and second target arranged such that the first plane and the second plane are arranged perpendicular to each other, the position function P may describe the relative position between the connected modules in all three spatial dimensions over time. Specifically, the position function P may be a function f, dependent on the first spatial dimension x, the second spatial dimension y, the third spatial dimension z and on the time t. As an example, P=f(x,y,z,t), specifically P=P₁+P₂.

The first sensor signal and the second sensor signal may both be gradient field sensor signals. Thus, as an example, both the first sensor signal, i.e. generated by the first position sensor, and the second sensor signal, i.e. generated by the second position sensor, may be transferred into gradient field sensor signals, specifically by the processing unit, for example by calculating the gradient of both the first sensor signal and the second sensor signal.

Further, the processing unit may be configured for determining both a translational and a rotational change in position, specifically a translational and a rotational movement, such as a tilt and/or torsion, between the two connected modules from at least two gradient field sensor signals. In particular, the processing unit may be configured for generating a rotational position function R describing relative position between the connected modules in both the first plane and the second plane over the time while further describing a possible tilt and/or rotation between the connected modules. Thus, compared to the position function P, the rotational position function R may further provide information on a tilted and/or rotated relative position between the connected modules. As an example, in case the sensor signal of the at least two position sensors are provided to the processing unit in different coordinate systems, i.e. in at least one polar coordinate system and/or in different Euclidean coordinate systems, processing unit may further perform the at least one transformation, i.e. by using commonly known transformation techniques, e.g. by using at least one transformation matrix, such that the sensor signals may be described in the same coordinate system. Specifically, the rotational position function R may be a function f, dependent on the first spatial dimension x, the second spatial dimension y, the third spatial dimension z, a rotation r and on the time t. As an example, R=f(x,y,z,r,t).

The position tracking system may comprise at least one further sensor configured for generating a further sensor signal according to at least one further parameter, i.e. configured for measuring the at least one further parameter. As an example, the at least one further sensor may be at least one sensor selected from the group consisting of a temperature sensor and a humidity sensor.

As an example, the humidity sensor, i.e. a moisture sensor, may be configured for generating at least one humidity sensor signal according to a humidity, such as an air humidity, in the vicinity of the at least two connected modules. In particular, the humidity sensor may be arranged within a 10 m radius of the connected modules, for example within the same room as the at least two connected modules. As an example, the humidity sensor signal H generated by the humidity sensor may describe a humidity over time t. Thus, as an example, the humidity sensor signal H may be a function f, dependent on the time t, i.e. H=f_{H}(t).

In particular, the temperature sensor may be configured for generating at least one temperature sensor signal according to a temperature in the vicinity of the at least two connected modules. in particular, the temperature sensor may be arranged within a 10 m radius of the connected modules, for example within the same room at the at least two connected modules. As an example, the temperature sensor signal T generated by the temperature sensor may describe a temperature over time t. Thus, as an example, the temperature sensor signal T may be a function f, dependent on the time t, i.e. T=f_{T}(t).

As an example, the further sensor may be integrated into the at least one position sensor, for example into at least one of the first position sensor and the second position sensor. Thus, the at least one sensor signal S, specifically the first sensor signal S₁ and/or the second sensor signal S₂, generated by the at least one position sensor may further comprise information on a further parameter, i.e. on the temperature and/or on the humidity, in the vicinity of the connected modules. As an example, S₁=f(x,y,t,T) and/or S₂=f(x,z,t,T).

The processing unit may specifically be configured for considering the at least one further sensor signal when determining the relative position between the connected modules. In particular, the processing unit may be configured for generating a further function U describing the relative position between the connected modules in both the first plane and the second plane over the time, describing a possible tilt and/or rotation between the connected modules and further considering one or more of the parameters measured by the further sensor, i.e. the temperature, in the vicinity of the at least two connected modules. Specifically, compared to the rotational position function R, the further function U may further provide information on the further parameter, i.e. on one or both of the temperature and the humidity, in the vicinity of the connected modules. Specifically, the further function U may be a function f, dependent on the first spatial dimension x, the second spatial dimension y, the third spatial dimension z, a rotation r, over time t, further depending on the further parameter, such as on the temperature T. As an example, U=f(x,y,z,r,t,T). Additionally or alternatively, U=f(x,y,z,r,t,H) or U=f(x,y,z,r,t,T,H).

In a further aspect of the present invention a monitoring system for monitoring at least two connected modules is disclosed. The monitoring system comprises at least one position tracking system. For definitions and embodiments of the position tracking system reference is made to the definitions and embodiments as outlined in the context of the position tracking system above or as further described below. Further, the monitoring system comprises at least one evaluation unit configured to generate, specifically calculate, at least one item of movement information related to a change in the relative position between the two connected modules.

In particular, the evaluation unit may be configured for generating the item of movement information by using the relative position between the at least two connected modules as tracked by the position tracking system. As an example, the evaluation unit may calculate the item of movement information from the relative position between the connected modules. The term “item of movement information” as used herein is a broad term and is to be given its ordinary and customary meaning to a person of ordinary skill in the art and is not to be limited to a special or customized meaning. The term specifically may refer, without limitation, to an arbitrary item of information, e.g. one or more numerical values, which quantify at least one property and/or characteristic of a change in the relative position between the at least two connected modules. As an example, the item of movement information may be or may comprise at least one numerical value related to a movement between the at least two connected modules. In particular, the item of movement information may be or may comprise information selected from the group consisting of: a distance between an optimal position and an actual position, such as a maximum deviation from a predefined position optimum; an acceleration, such as a maximum acceleration, for example of a vibrational movement.

The term “vibrational movement” as used herein is a broad term and is to be given its ordinary and customary meaning to a person of ordinary skill in the art and is not to be limited to a special or customized meaning. The term specifically may refer, without limitation, to low-frequency vibrations, particularly including vibrations caused by impacts, specifically impacts on at least one module and/or unit. The sensor may be operated in a low frequency sampling mode and/or in a high frequency sampling mode for detecting the respective frequency range. The vibrational movement may be recorded over time. Vibrational movement may be, exemplarily, considered as a change in position as a function of time. Such a function of time may be transformed from the time domain into the frequency domain by using a Fourier transformation, specifically a Fast Fourier Transformation. Particularly, in such a Fourier transformation, specifically a Fast Fourier Transformation, high amplitude peaks may be selected in the time domain for processing into the frequency domain. From this, it is possible to detect at least one frequency and/or at least one external vibrations causing the vibrational movement of the at least one module and/or unit.

Further, the evaluation unit may be configured for generating at least one item of recommendation information from the item of movement information by evaluating the item of movement information in view of predetermined reference data, i.e. previously collected data, such as predetermined threshold data. Specifically, the evaluation unit may generate the item of recommendation information by evaluating the item of movement information using previously determined data, for example by comparing the item of movement information with at least one predetermined threshold data, i.e. checking whether threshold values and/or limits are exceeded. The term “item of recommendation information” as used herein is a broad term and is to be given its ordinary and customary meaning to a person of ordinary skill in the art and is not to be limited to a special or customized meaning. The term specifically may refer, without limitation, to an arbitrary item of information, e.g. one or more numerical values, which comprise instructions and/or advice on a setting, specifically an environmental setting, a behavior or a practice. As an example, the item of recommendation information may comprise information on advantageous settings of the connected modules, such as an advantageous positioning of at least one of the connected modules. Additionally or alternatively, the item of recommendation information may comprise information on advantageous environmental settings of the connected modules, such as an advantageous temperature range, i.e. in order to minimize environmentally induced position changes. The recommendation information may comprise advantageous suggestions to be applied to the at least two connected modules or even to the whole modular diagnostic laboratory, such as for example a recommendation to ventilate, air-condition or heat an area where the two modules are stationed.

As an example, the item of recommendation information may be generated, specifically by thee evaluation unit, from the item of movement information by automatically searching for correlations between predetermined reference data, i.e. previously collected data, with the item of movement information. In particular, the evaluation unit may be configured for automatically detecting and evaluating correlations within the data, such as to identify patterns between at least one setting of the connected modules, i.e. environmental conditions the connected modules are subjected to, and a change in relative position between the at least two connected modules. As an example, the evaluation unit may be configured for automatically identifying correlations between the item of movement information and service cases, such as a performed repair and/or maintenance interval.

In particular, the item of recommendation information may be selected from the group consisting of: an ideal temperature range, such as an ideal temperature range of a room in which the connected modules are arranged; a maintenance interval, such as a time range in which maintenance should be performed; a lifetime prediction, such as a prediction of time left before damage or failure of at least one of the connected modules, for example under current environmental conditions, i.e. under current temperature and/or humidity conditions; a tolerance prediction, such as a prediction of tolerance chains under current environmental conditions.

In a further aspect of the present invention, a method for tracking a relative position between at least two connected modules by using at least one position tracking system is disclosed. As an example, herein, the method for tracking a relative position between at least two connected modules by using at least one position tracking system may also be referred to as “tracking method”. The method comprises the following steps that may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps that are not listed. For definitions and embodiments, for example of the position tracking system, reference is made to the definitions and embodiments as outlined above or as described in more detail below.

The method for tracking a relative position between at least two connected modules by using at least one position tracking system, i.e. the tracking method, comprises:
a) providing the at least one position tracking system;
b) generating, by using the at least one position sensor, at least one sensor signal according to the relative position between the at least one position sensor and the at least one target;
c) tracking, by using the processing unit, at least one relative position between the connected modules in at least two spatial dimensions by using the at least one sensor signal.

Further, step c) may comprise determining a change in the relative position between the connected modules by transferring the sensor signal into a gradient sensor signal, specifically by calculating at least one gradient of the at least one sensor signal.

In yet a further aspect of the present invention, a method for monitoring at least two connected modules by using at least one monitoring system is disclosed. In particular, herein, the method for monitoring at least two connected modules by using at least one monitoring system may also be referred to as “monitoring method”. The method comprises the following steps that may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps that are not listed. For definitions and embodiments, for example of the monitoring system and/or the position tracking system, reference is made to the definitions and embodiments as outlined above or as described in more detail below.

The method for monitoring at least two connected modules by using at least one monitoring system, i.e. the monitoring method, comprises:
i) providing the at least one monitoring system;
ii) tracking a relative position between the at least two connected modules by performing the method for tracking a relative position between at least two connected modules according to any one of the preceding method claims;
iii) generating, specifically by using the evaluation unit, at least one item of movement information from the relative position tracked in step ii).

Further, the monitoring method may comprise the following step:
iv) generating at least one item of recommendation information from the item of movement information and predetermined reference data, i.e. previously collected data, specifically by using the evaluation unit.

Further disclosed and proposed herein is a tracking computer program comprising instructions which, when the program is executed by the position tracking system, cause the position tracking system to perform at least one of steps b) and c) of the tracking method. In particular, the tracking program may include computer-executable instructions for performing the tracking method according to the present invention in one or more of the embodiments enclosed herein when the program is executed on the position tracking system, i.e. on the processing unit of the position tracking system, for example on a processor of a computer or computer network. Specifically, the tracking computer program may be stored on a computer-readable data carrier and/or on a computer-readable storage medium. Thus, further disclosed and proposed herein is a position tracking computer-readable storage medium comprising instructions which, when the position tracking computer program is executed by the position tracking system, cause the position tracking system to perform at least one of steps b) and c) of the tracking method.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Specifically, one, more than one or even all of tracking method steps a) to c) as indicated above may be performed by using a computer or a computer network, preferably by using a computer program.

Further disclosed and proposed herein is a monitoring computer program comprising instructions which, when the program is executed by the monitoring system, cause the monitoring system to perform at least one of steps ii) and iii) and optionally step iv) of the monitoring method. In particular, the monitoring program may include computer-executable instructions for performing the monitoring method according to the present invention in one or more of the embodiments enclosed herein when the program is executed on the monitoring system. Specifically, the monitoring computer program may be stored on a computer-readable data carrier and/or on a computer-readable storage medium. Thus, further disclosed and proposed herein is a monitoring computer-readable storage medium comprising instructions which, when the monitoring computer program is executed by the monitoring system, cause the monitoring system to perform at least one of steps ii) and iii) and optionally step iv) of the monitoring method.

Specifically, one, more than one or even all of monitoring method steps i) to iv) as indicated above may be performed by using a computer or a computer network, preferably by using a computer program.

Further disclosed and proposed herein is a computer program product having program code means, in order to perform one or more of the tracking method and the monitoring method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute one or more of the tracking method and the monitoring method according to one or more of the embodiments disclosed herein.

Further disclosed and proposed herein is a computer program product with program code means stored on a machine-readable carrier, in order to perform one or more of the tracking method and the monitoring method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing one or more of the tracking method and the monitoring method according to one or more of the embodiments disclosed herein.

Referring to the computer-implemented aspects of the invention, one or more of the method steps or even all of the method steps of the tracking method and/or the monitoring method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

The systems and methods according to the present invention provide a large number of advantages over known methods and devices of similar kind. Specifically the position tracking system may allow for a robust tracking of a relative position between at least two connected modules. In particular, the proposed systems and methods may be less prone to error or failure than systems and methods known in the art. Further, maintenance costs and operating expenses for the position tracking system and the monitoring system may be very low.

Specifically, the proposed systems and methods may reduce errors requiring service, such as maintenance and repair, by allowing for an error-preventive operation of connected modules, i.e. of modular diagnostic laboratories. In particular, the present systems and methods may allow for a predictive maintenance of the connected modules and/or even for modular diagnostic laboratories as a whole, i.e. by allowing to identify even minor changes in relative position and thus requesting service and/or maintenance before errors occur.

Further, the proposed systems and methods, i.e. by may allow for a detection of an ideal laboratory temperature band, may allow for a more sustainable and environmentally friendly operation of modular diagnostic laboratories. In particular, the proposed systems and methods may allow for reducing the quantity of repairs and maintenance necessary for operating modular diagnostic laboratories. Furthermore, as an example, more sustainable decisions might be possible regarding acquisition and operation of further equipment, such as cooling systems or radiators, or for planning of maintenance or service times. Specifically, the present systems and methods may allow to determine a movement topology over whole modular diagnostic laboratory, i.e. for each connected module and/or each interface between at least two connected modules. Thereby, the proposed systems and methods may allow for identifying hot spots and thus, prediction of necessary service or maintenance visits and/or proactive and forward-looking planning of time resources for service or maintenance visits, may be possible. In addition, by allowing detection of changes in relative position, i.e. position drift, the present systems and methods may allow for initiating preventive and/or predictive maintenance visits.

Summarizing and without excluding further possible embodiments, the following embodiments may be envisaged:

### Embodiment 1

A position tracking system for tracking a relative position between at least two connected, specifically mechanically interacting, modules, the position tracking system comprising:
at least one target associated with a first one of the at least two connected modules;
at least one position sensor associated with a second one of the at least two connected modules, wherein the position sensor is configured for generating at least one sensor signal according to a relative position between the at least one position sensor and the at least one target; and
at least one processing unit, such as a processor, configured for tracking a relative position between the connected modules from the at least one sensor signal in at least one plane.

### Embodiment 2

The position tracking system according to the preceding embodiment, wherein the at least one target is at least one of arranged on and arranged within the first one of the at least two connected modules.

### Embodiment 3

The position tracking system according to any one of the preceding embodiments, wherein the at least one position sensor is at least one of arranged on and arranged within the second one of the at least two connected modules.

### Embodiment 4

The position tracking system according to any one of the preceding embodiments, wherein the at least one sensor signal is a gradient field sensor signal, specifically the processing unit is configured for transferring the sensor signal into the gradient field sensor signal by calculating at least one gradient of the at least one sensor signal.

### Embodiment 5

The position tracking system according to any one of the preceding embodiments, wherein the position tracking system comprises at least two targets and at least two position sensors.

### Embodiment 6

The position tracking system according to the preceding embodiment, wherein a first position sensor and a first target are arranged on different connected modules, wherein the first position sensor is configured to generate a first sensor signal, wherein the first sensor signal comprises information on a the relative position over time, i.e. on a movement, between the first target and the first position sensor in a first plane, and wherein a second position sensor and a second target are arranged on different connected modules, wherein the second position sensor is configured to generate a second sensor signal, wherein the second sensor signal comprises information on the relative position over time, i.e. on a movement, between the second target and the second position sensor in a second plane, wherein the first plane differs from the second plane.

### Embodiment 7

The position tracking system according to the preceding embodiment, wherein the first position sensor and the second position sensor are arranged such that the first plane and the second plane are arranged in an essentially orthogonal fashion.

### Embodiment 8

The position tracking system according to any one of the two preceding embodiments, wherein the processing unit is configured for determining a translational change in position, such as a translational movement, between the two connected modules from the first sensor signal and the second sensor signal.

### Embodiment 9

The position tracking system according to any one of the three preceding embodiments, wherein both the first sensor signal and the second sensor signal are gradient field sensor signals and wherein the processing unit is configured for determining both a translational and a rotational change in position, specifically a translational and a rotational movement, such as a tilt and/or torsion, between the two connected modules from at least two gradient field sensor signals.

### Embodiment 10

The position tracking system according to any one of the preceding embodiments, further comprising at least one further sensor configured for generating a further sensor signal according to at least one further parameter, i.e. configured for measuring the at least one further parameter, wherein the further sensor is selected from the group consisting of: a temperature sensor and/or a humidity sensor.

### Embodiment 11

The position tracking system according to the preceding embodiment, wherein the humidity sensor is configured for generating at least one humidity sensor signal according to a humidity, specifically a room humidity, in the vicinity of the at least two connected modules.

### Embodiment 12

The position tracking system according to any one of the two preceding embodiments, wherein the temperature sensor is configured for generating at least one temperature sensor signal according to a temperature, specifically a room temperature, in the vicinity of the at least two connected modules.

### Embodiment 13

The position tracking system according to any one of the two preceding embodiments, wherein the processing unit is further configured for considering the at least one further sensor signal, i.e. dependent on the temperature and/or the humidity, when determining the relative position between the connected modules.

### Embodiment 14

The position tracking system according to any one of the preceding embodiments, wherein the at least one position sensor is selected from the group consisting of: an inductive sensor, a capacitive sensor, an optical sensor, and a magnetoresistance sensor; specifically selected from the group consisting of: an anisotropic magnetoresistance sensor, a giant magnetoresistance sensor, a colossal magnetoresistance sensor, and a tunnel magnetoresistance sensor.

### Embodiment 15

A monitoring system for monitoring at least two connected modules, the monitoring system comprising:
the position tracking system according to any one of the preceding embodiments; and
at least one evaluation unit configured to generate, specifically calculate, at least one item of movement information related to a change in the relative position between the two connected modules.

### Embodiment 16

The monitoring system according to the preceding embodiment, wherein the item of movement information is information selected from the group consisting of: a distance between an optimal position and an actual position, such as a maximum deviation from a predefined position optimum; and an acceleration, such as a maximum acceleration, for example of a vibrational movement.

### Embodiment 17

The monitoring system according to any one of the two preceding embodiments, wherein the evaluation unit is further configured for generating at least one item of recommendation information from the item of movement information by evaluating the item of movement information in view of predetermined reference data, i.e. previously collected data, such as predetermined threshold data.

### Embodiment 18

The monitoring system according to the preceding embodiment, wherein the item of recommendation information is generated from the item of movement information by automatically searching for correlations between predetermined reference data, i.e. previously collected data, with the item of movement information.

### Embodiment 19

The monitoring system according to any one of the two preceding embodiments, wherein the item of recommendation information is selected from the group consisting of: an ideal temperature range, such as an ideal temperature range of a room in which the connected modules are arranged; a maintenance interval, such as a time range in which maintenance should be performed; a lifetime prediction, such as a prediction of time left before damage or failure of at least one of the connected modules, for example under current environmental conditions, i.e. under current temperature and/or humidity conditions; and a tolerance prediction, such as a prediction of tolerance chains under current environmental conditions.

### Embodiment 20

A method for tracking a relative position between at least two connected modules by using at least one position tracking system according to any one of the preceding embodiments referring to a position tracking system, the method comprising:
a) providing the at least one position tracking system;
b) generating, by using the at least one position sensor, at least one sensor signal according to the relative position between the at least one position sensor and the at least one target;
c) tracking, by using the processing unit, at least one relative position between the connected modules in at least two spatial dimensions by using from the at least one sensor signal.

### Embodiment 21

The method according to the preceding embodiment, wherein step c) comprises determining a change in the relative position between the connected modules by transferring the sensor signal into a gradient sensor signal, specifically by calculating at least one gradient of the at least one sensor signal.

### Embodiment 22

A method for monitoring at least two connected modules by using at least one monitoring system according to any one of the preceding embodiments referring to a monitoring system, the method comprising:
i) providing the at least one monitoring system;
ii) tracking a relative position between the at least two connected modules by performing the method for tracking a relative position between at least two connected modules according to any one of the preceding method embodiments;
iii) generating, specifically by using the evaluation unit, at least one item of movement information from the relative position tracked in step ii).

### Embodiment 23

The method according to the preceding embodiment, further comprising:
iv) generating at least one item of recommendation information from the item of movement information and predetermined reference data, i.e. previously collected data, specifically by using the evaluation unit.

### Embodiment 24

A position tracking computer program comprising instructions which, when the program is executed by the position tracking system according to any one of the preceding embodiments referring to a position tracking system, cause the position tracking system to perform at least one of steps b) and c) of the tracking method according to any one of the preceding embodiments referring to a method for tracking a relative position between at least two connected modules by using at least one position tracking system.

### Embodiment 25

A position tracking computer-readable storage medium comprising instructions which, when the position tracking computer program is executed by the position tracking system according to any one of the preceding embodiments referring to a position tracking system, cause the position tracking system to perform at least one of steps b) and c) of the tracking method according to any one of the preceding embodiments referring to a method for tracking a relative position between at least two connected modules by using at least one position tracking system.

### Embodiment 26

A monitoring computer program comprising instructions which, when the program is executed by the monitoring system according to any one of the preceding embodiments referring to a monitoring system, cause the monitoring system to perform at least one of steps ii) and iii) and optionally step iv) of the monitoring method according to any one of the preceding embodiments referring to a method for monitoring at least two connected modules by using at least one monitoring system.

### Embodiment 27

A monitoring computer-readable storage medium comprising instructions which, when the monitoring computer program is executed by the monitoring system according to any one of the preceding embodiments referring to a monitoring system, cause the monitoring system to perform at least one of steps ii) and iii) and optionally step iv) of the monitoring method according to any one of the preceding embodiments referring to a method for monitoring at least two connected modules by using at least one monitoring system.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of monitoring system comprising an embodiment of a tracking system in a top plane view;

FIG. 2 shows an embodiment of a position tracking system in a top plane view;

FIG. 3 shows an embodiment of a position tracking system in a perspective view;

FIG. 4 shows a flow chart of a tracking method;

FIGS. 5 and 6 show different flow charts of monitoring methods; and

FIG. 7 shows exemplarily the generation of a rotational position function R.

### DETAILED DESCRIPTION OF THE EMBODIMENTS

In FIG. 1, an embodiment of a monitoring system 110 is illustrated in a top plane view, i.e. from above. The monitoring system 110 comprises a position tracking system 112 for tracking a relative position between at least two connected modules 114 and at least one evaluation unit 116 configured to generate at least one item of movement information related to a change in the relative position between the two connected modules 114. The position tracking system 112 comprises at least one target 118 associated with a first one of the at least two connected modules 114. As an example, the target 118 may be arranged within the first one of the at least two connected modules 114. Further, the position tracking system 112 comprises at least one position sensor 120 associated with a second one of the at least two connected modules and 114, wherein the position sensor 120 is configured for generating at least one sensor signal according to a relative position between the at least one position sensor 120 and the at least one target 118. As an example, the position sensor 120 may be arranged both on and within the second one of the at least two connected modules 114: the position tracking system 112 further comprises at least one processing unit 122 configured for tracking the relative position between the connected modules 114 from the at least one sensor signal in at least one plane 124. In FIG. 1, for illustrational purposes, vectors x and y of a Cartesian coordinate system 126 are shown to span the plane 124. However, other coordinate system, such as a polar coordinate system, for describing the plane 124 may be used.

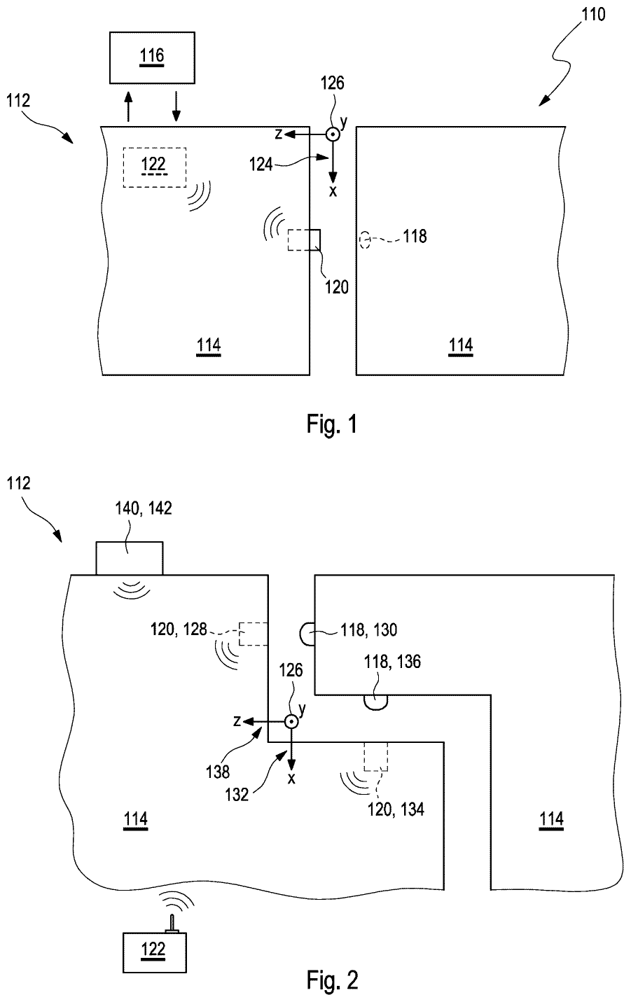

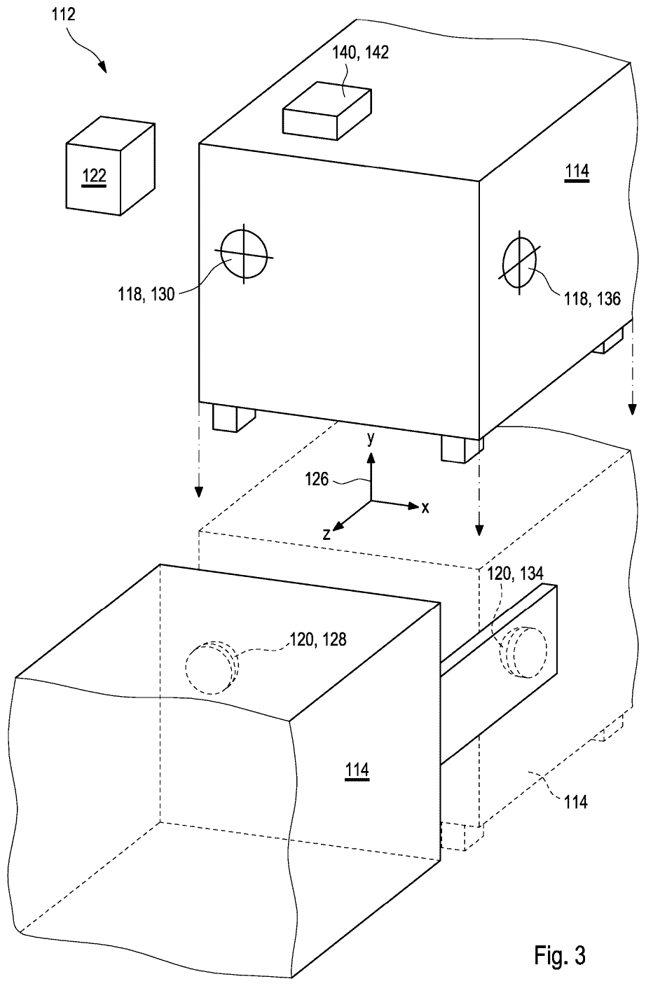

FIGS. 2 and 3 show different embodiments of a position tracking system 112. The position tracking system 112 may specifically comprise at least two targets 118 and at least two position sensors 120. In particular, a first position sensor 128 and a first target 130 may be arranged on different connected modules 114. The first position sensor 128 may specifically be configured to generate a first sensor signal according to the relative position between the first target 130 and the first position sensor 128. In particular, the first sensor signal thus may comprise information on the relative position between the first target 130 and the first position sensor 128 over time, i.e. on a movement, such as on a relative movement, for example in a first plane 132. In FIGS. 2, vectors x and y of the Cartesian coordinate system 126 are illustrated to span the first plane 132. Further, a second position sensor 134 and a second target 136 may be arranged on different connected modules 114. The second position sensor 134 may specifically be configured to generate a second sensor signal according to the relative position between the second target 136 and the second position sensor 134. In particular, the second sensor signal thus may comprise information on the relative position between the second target 136 and the second position sensor 134 over time, i.e. on a movement, such as on a relative movement, for example in a second plane 138. Specifically, the first plane 132 and the second plane 138 may be arranged in an essentially orthogonal fashion, i.e. by a corresponding positioning of the first and second position sensors 128, 134.

In particular, the processing unit 122 may be configured for determining a translational change in position, such as a translational movement, between the two connected modules 114 from the first sensor signal, i.e. generated by the first position sensor 128, and the second sensor signal, i.e. generated by the second position sensor 134. For this purpose, the position sensors 120, specifically the first and second position sensors 128, 134, may be configured for transmitting the sensor signals to the processing unit 122.

The position tracking system 112 may comprise at least one further sensor 140 configured for generating a further sensor signal according to at least one further parameter. As an example, the further sensor 140 may specifically be or may comprise a temperature sensor 142, wherein the temperature sensor 142 may be configured for generating at least one temperature sensor signal according to a temperature in the vicinity of the at least two connected modules 114. In particular, the processing unit 122 may further be configured for considering the at least one further sensor signal, i.e. the temperature sensor signal generated by the temperature sensor 142, when determining the relative position between the connected modules 114. Additionally or alternatively, the further sensor 140 may be integrated into the position sensor 120, i.e. into at least one of the first position sensor 128 and the second position sensor 134. Thus, as an example, the sensor signal generated by the at least one position sensor 120 may further comprise information on the at least one further parameter, i.e. on the temperature.

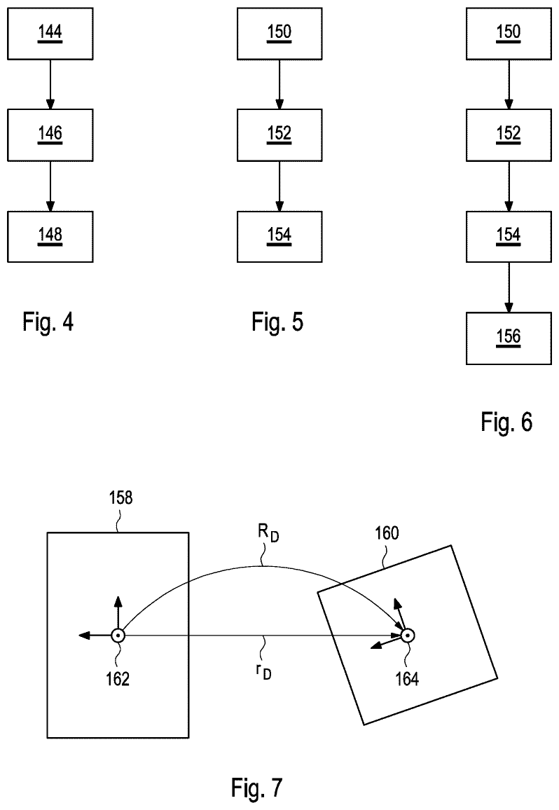

In FIG. 4 a flowchart of a tracking method, specifically of a method for tracking a relative position between at least two connected modules 114 by using at least one position tracking system 112 is illustrated. The tracking method comprises the following steps:
a) (denoted by reference number 144) providing the at least one position tracking system 112;
b) (denoted by reference number 146) generating, by using the at least one position sensor 120, at least one sensor signal according to the relative position between the at least one position sensor 120 and the at least one target 118;
c) (denoted by reference number 148) tracking, by using the processing unit 122, at least one relative position between the connected modules 114 in at least two spatial dimensions by using the at least one sensor signal.

FIGS. 5 and 6 illustrate different flow chart of monitoring methods, i.e. of methods for monitoring at least two connected modules 114 by using at least one monitoring system 110. The monitoring method comprises the following steps:
i) (denoted by reference number 150) providing the at least one monitoring system 110;
ii) (denoted by reference number 152) tracking a relative position between the at least two connected modules 114 by performing the method for tracking a relative position between at least two connected modules 114;
iii) (denoted by reference number 154) generating, specifically by using the evaluation unit 116, at least one item of movement information from the relative position tracked in step ii).

Further, the monitoring method may comprise the following step:
iv) (denoted by reference number 156) generating at least one item of recommendation information from the item of movement information and predetermined reference data, i.e. previously collected data, specifically by using the evaluation unit 116.

According to FIG. 7, a first connected module 158 may be positioned and/or arranged, specifically tilted, with respect to a second connected module 160. For exemplarily generating the rotational position function R=f(x,y,z,r,t), a first reference frame 162 may be assumed being inertially fixed to the first connected module 158. Further, a second reference frame 164 may be assumed being inertially fixed to the second connected module 160.

Any tracking of the relative position between the first connected module 158 and the second connected module 160, may be performed with respect to the first reference frame 162. Thereby, possible values measured, specifically by at least two position sensors may be collected in a vector, specifically a vector

t_{D}=[x_{D}, y_{D}, z_{D}, ψ_{D}, θ_{D}, φ_{D}]^{T},

wherein the vector t_{D}, and specifically the entries of the vector, may be given in the coordinates of the second reference frame 164, as here and further indicated by using the index D. The entry x_{D} may refer to a first spatial dimension x_{D}, the entry y_{D} may refer to a second spatial dimension y_{D}, and the entry z_{D} may refer to a third spatial dimension. Further, the entry ψ_{D} may refer to a value of rotation around the x-axis, the entry θ_{D} may refer to a value of rotation around the y-axis, and the entry OD may refer to a value of rotation around the z-axis, thereby defining a rotation r.

The pose of the second reference frame 164, specifically the pose of the second connected module 160, with respect to the first reference frame 162 is described by a homogeneous transformation A_{D} in symmetry group [symbol] [symbol] (3), particularly parametrized by the vector t_{D}, wherein

$${A}_{D} = [ \begin{matrix}{R}_{D} & {r}_{D} \\ 0 & 1\end{matrix} ] , \\ with \\ {R}_{D} ( {t}_{D} ) = Rot [ z , {ψ}_{D} ] \cdot Rot [ y , {θ}_{D} ] \cdot Rot [ x , {φ}_{D} ] \\ and \\ {r}_{D} ( {t}_{D} ) = Trans [ x , {x}_{D} ] \cdot Trans [ y , {y}_{D} ] \cdot Trans [ z , {z}_{D} ] ,$$

wherein r_{D} is the radius vector from the origin of first reference frame 162 to the second reference frame 164 in coordinates of the first reference frame 162, and wherein R_{D} is the rotational position function, specifically also denoted as R=f(x,y,z,r), transforming the coordinates with respect to the first reference frame 162 into coordinates with respect to the second reference frame 164. The spatial dimensions x, y, z without the index D refer to the respective entries in coordinates of the first reference frame 162.

The repetition of this process results in an additional parameter t, which refers to the time. In this case R=f(x,y,z,r,t).

### LIST OF REFERENCE NUMBERS

110 monitoring system
112 position tracking system
114 connected module
116 evaluation unit
118 target
120 position sensor
122 processing unit
124 plane
126 Cartesian coordinate system
128 first position sensor
130 first target
132 first plane
134 second position sensor
136 second target
138 second plane
140 further sensor
142 temperature sensor
144 step a)
146 step b)
148 step c)
150 step i)
152 step ii)
154 step iii)
156 step iv)
158 first connected module
160 second connected module
162 first reference frame
164 second reference frame
R_{D} rotational position function
r_{D} radius vector

1. A position tracking system for tracking a relative position between at least two connected modules, the position tracking system comprising:
at least one target associated with a first one of the at least two connected modules, wherein the at least one target is at least one of arrangeable on and arrangeable within the first one of the at least two connected modules, wherein the at least two connected module are mechanically interacting entities and/or components, configured for allowing transport of objects from one module to the other module;
at least one position sensor associated with a second one of the at least two connected modules, wherein the position sensor is configured for generating at least one sensor signal according to a relative position between the at least one position sensor and the at least one target, wherein the at least one position sensor is at least one of arrangeable on and arrangeable within the second one of the at least two connected modules;
at least one processing unit configured for tracking a relative position between the connected modules from the at least one sensor signal in at least one plane; and
at least one further sensor configured for generating a further sensor signal according to at least one further parameter, wherein the further sensor is selected from the group consisting of: a temperature sensor and/or a humidity sensor, wherein the processing unit is further configured for considering the at least one further sensor signal when determining the relative position between the connected modules.

2. The position tracking system according to claim 1, wherein the at least one sensor signal is a gradient field sensor signal.

3. The position tracking system according to claim 1, wherein the position tracking system comprises at least two targets and at least two position sensors.

4. The position tracking system according to claim 3, wherein a first position sensor and a first target are arranged on different connected modules, wherein the first position sensor is configured to generate a first sensor signal, wherein the first sensor signal comprises information on a the relative position over time between the first target and the first position sensor in a first plane, and wherein a second position sensor and a second target are arranged on different connected modules, wherein the second position sensor is configured to generate a second sensor signal, wherein the second sensor signal comprises information on the relative position over time between the second target and the second position sensor in a second plane, wherein the first plane differs from the second plane.

5. The position tracking system according to claim 4, wherein the first position sensor and the second position sensor are arranged such that the first plane and the second plane are arranged in an essentially orthogonal fashion.

6. The position tracking system according to claim 4, wherein the processing unit is configured for determining a translational change in position between the two connected modules from the first sensor signal and the second sensor signal.

7. The position tracking system according to claim 4, wherein both the first sensor signal and the second sensor signal are gradient field sensor signals and wherein the processing unit is configured for determining both a translational and a rotational change in position between the two connected modules from the two gradient field sensor signals.

8. A monitoring system for monitoring at least two connected modules, the monitoring system comprising:
the position tracking system according to claim 1; and
at least one evaluation unit configured to generate at least one item of movement information related to a change in the relative position between the two connected modules.

9. The monitoring system according to claim 8, wherein the evaluation unit is further configured for generating at least one item of recommendation information from the item of movement information by evaluating the item of movement information in view of predetermined reference data.

10. The monitoring system according to claim 9, wherein the item of recommendation information is generated from the item of movement information by automatically searching for correlations between predetermined reference data.

11. The monitoring system according to claim 9, wherein the item of recommendation information is selected from the group consisting of: an ideal temperature range; a maintenance interval; a lifetime prediction; and a tolerance prediction.

12. A method for tracking a relative position between at least two connected modules by using at least one position tracking system according to claim 1, the method comprising:
a) providing the at least one position tracking system;
b) generating, by using the at least one position sensor, at least one sensor signal according to the relative position between the at least one position sensor and the at least one target; and
c) tracking, by using the processing unit, at least one relative position between the connected modules in at least two spatial dimensions by using the at least one sensor signal.

13. The method according to claim 12, wherein step c) comprises determining a change in the relative position between the connected modules by transferring the sensor signal into a gradient sensor signal.

14. A method for monitoring at least two connected modules by using an at least one monitoring system, the method comprising:
i) providing the at least one monitoring system, the monitoring system comprising:
a position tracking system for tracking a relative position between at least two connected modules, the position tracking system comprising:
at least one target associated with a first one of the at least two connected modules, wherein the at least one target is at least one of arrangeable on and arrangeable within the first one of the at least two connected modules, wherein the at least two connected module are mechanically interacting entities and/or components, configured for allowing transport of objects from one module to the other module;
at least one position sensor associated with a second one of the at least two connected modules, wherein the position sensor is configured for generating at least one sensor signal according to a relative position between the at least one position sensor and the
at least one target, wherein the at least one position sensor is at least one of arrangeable on and arrangeable within the second one of the at least two connected modules;
at least one processing unit configured for tracking a relative position between the connected modules from the at least one sensor signal in at least one plane; and
at least one further sensor configured for generating a further sensor signal according to at least one further parameter, wherein the further sensor is selected from the group consisting of: a temperature sensor and/or a humidity sensor, wherein the processing unit is further configured for considering the at least one further sensor signal when determining the relative position between the connected modules; and
at least one evaluation unit configured to generate at least one item of movement information related to a change in the relative position between the two connected modules;
ii) tracking a relative position between the at least two connected modules by performing the method of claim 12 for tracking a relative position between at least two connected modules; and
iii) generating at least one item of movement information from the relative position tracked in step ii).
